(19) United States
(12) Patent Application Publication
(10) Pub. No.: US 2011/0131998 A1
(43) Pub. Date: Jun. 9, 2011

(54) FUEL INJECTION IN SECONDARY FUEL NOZZLE

(76) Inventors: Vaibhav NADKARNI, Bangalore (IN); Manish Kumar, Bangalore (IN); Abdul Rafey Khan, Greenville, SC (US)

(21) Appl. No.: 12/633,330

(22) Filed: Dec. 8, 2009

(51) Int. Cl. F02C 7/22

(52) U.S. Cl. 60/737; 60/742

(57) ABSTRACT

In a conventional secondary fuel nozzle for a gas turbine combustion system, secondary air enters and flows around pegs to mix with fuel injected through holes in pegs. Because the pegs are in the air flow area, undesirable pressure drops occur adversely affecting turbine's efficiency and leading to higher emissions. A novel secondary fuel nozzle is provided in which fuel is injected upstream of the secondary air entry location, which allows the pegs to be removed from the flow area. An example secondary fuel nozzle includes a nozzle body delivering fuel, a nozzle housing surrounding the nozzle body and defining air passages for the secondary air to enter and flow toward an end of the nozzle body, and a premix fuel unit positioned upstream of the air passages injecting fuel delivered by the nozzle body into the secondary air for premixing prior to combustion.

This invention relates to system and method for injecting fuel in secondary fuel nozzles in gas turbine systems.

### BACKGROUND OF THE INVENTION

Numerous regulations requiring reductions in the amount of emissions, especially nitrogen oxide (NOx) and carbon monoxide (CO), have been enacted by governmental agencies in an effort to reduce pollution from gas powered turbines. More efficient combustion processes, such as those provided by Dry Low NOx (DLN1) systems, can lead to lower combustion emissions.

Some early combustion systems utilized diffusion type nozzles that produce a diffusion flame. This is a type of nozzle that injects fuel and air separately and mixing occurs by diffusion in a flame zone. Diffusion type nozzles produce high emissions since fuel and air burn stoichiometrically at high temperatures.

To improve upon diffusion nozzles, fuel and air can be premixed such that the fuel and air mix prior to combustion to form a homogeneous mixture that burns at a lower temperature than the diffusion type flame producing lower NOx emissions. Premixing can occur either internal to the fuel nozzle or external thereto.

FIG. 1 schematically illustrates a gas turbine, which includes a combustion chamber 18 and a secondary fuel nozzle 10 disposed for injecting fuel into the chamber 18. Compressed secondary air 20 enters the secondary fuel nozzle 10 and flows in a rightward direction toward pegs 12 provided at discrete locations about the outer periphery of a nozzle body 16. The secondary fuel nozzle 10 is enclosed in a cap center nozzle body 24.

FIG. 2 illustrates in more detail a conventional design of the secondary fuel nozzle 10. A nozzle body 16 of secondary fuel nozzle 10 is surrounded by a cylindrical nozzle housing 210. Secondary air 20 enters through an air passage 220 provided on the nozzle housing 210. A diffusion pilot tube 11 injects fuel at a nozzle tip 14 directly into the combustion chamber 18 through a swirler to form a stable pilot flame.

The secondary fuel nozzle 10 also includes a plurality of discrete pegs 12, which are fed with fuel from a fuel delivery conduit 13. Pegs 12 are provided to disperse the fuel—i.e., to spray the fuel into the secondary air 20—to achieve a premix of fuel and air upstream of the combustion chamber. In this regard, pegs 12 act as injectors for injecting the fuel into the secondary air 20. Conventionally, round fuel pegs 12 are used with round fuel dispersion holes 22 to disperse the fuel as illustrated in FIG. 3.

Referring back to FIGS. 1 and 2, it is seen that in the conventional secondary fuel nozzle design, secondary air 20 enters the secondary fuel nozzle 10 and flows around the pegs 12 located downstream of the secondary air entry location and mixes with gaseous fuel through the holes of the pegs 12.

It will be appreciated that the pegs in the conventional secondary fuel nozzle can lead to a substantial pressure drop in the air flow since they are in the flow area of the secondary air. For example, when there are six pegs in the secondary fuel nozzle, the pegs block approximately 29% of the flow area. The resulting pressure drop can adversely affect overall efficiency of the turbine, which in turn can lead to increased emissions. Also, pegs limit ability to vary the delivery of fuel. Moreover, pegs limit flexibility to adapt to wide range of fuel volumetric flows.

### BRIEF SUMMARY OF THE INVENTION

A non-limiting aspect of the present invention relates to a secondary fuel nozzle which includes a nozzle body arranged deliver fuel for combustion in a gas turbine and a nozzle housing surrounding the nozzle body. The nozzle housing defines one or more air passages at predetermined lengthwise positions of the nozzle body such that the secondary air entering the nozzle housing flows from the one or more air passages towards one end of the nozzle body. A premix fuel unit, which is provided upstream of the one or more air passages, is arranged to inject fuel delivered by the nozzle body into the secondary air to premix the fuel and air prior to combustion.

Another non-limiting aspect of the present invention relates to a gas turbine, which includes a combustion chamber and a secondary fuel nozzle arranged to provide premixed fuel and air into the combustion chamber. The above described secondary fuel nozzle can be used in the gas turbine.

The invention will now be described in greater detail in connection with the drawings identified below.

### BRIEF DESCRIPTION OF THE DRAWINGS

FIG. 1 is a view of a gas turbine including a secondary fuel nozzle disposed therein;

FIG. 2 is a view of a conventional secondary fuel nozzle;

FIG. 3 a view of pegs of a conventional secondary fuel nozzle;

FIGS. 4 and 5 are side and perspective views of a non-limiting fuel injection location example upstream of secondary air entry location;

FIGS. 6 and 7 are perspective and cutout side views of a first non-limiting embodiment of a secondary fuel nozzle;

FIGS. 8 and 9 are views of non-limiting example fuel injection hole arrangements provided on a premix fuel unit of the first embodiment;

FIGS. 10 and 11 are respectively perspective and cutout side views of a second non-limiting embodiment of a secondary fuel nozzle;

FIG. 12 is a view of a non-limiting fuel manifold of the second embodiment;

FIGS. 13 and 14 are views of non-limiting example fuel injection hole arrangements provided on a premix fuel unit of the second embodiment;

FIGS. 15 and 16 are perspective and side views of a third non-limiting embodiment of a secondary fuel nozzle; and

FIGS. 17, 18, 19, and 20 are views of non-limiting variations of the third embodiment.

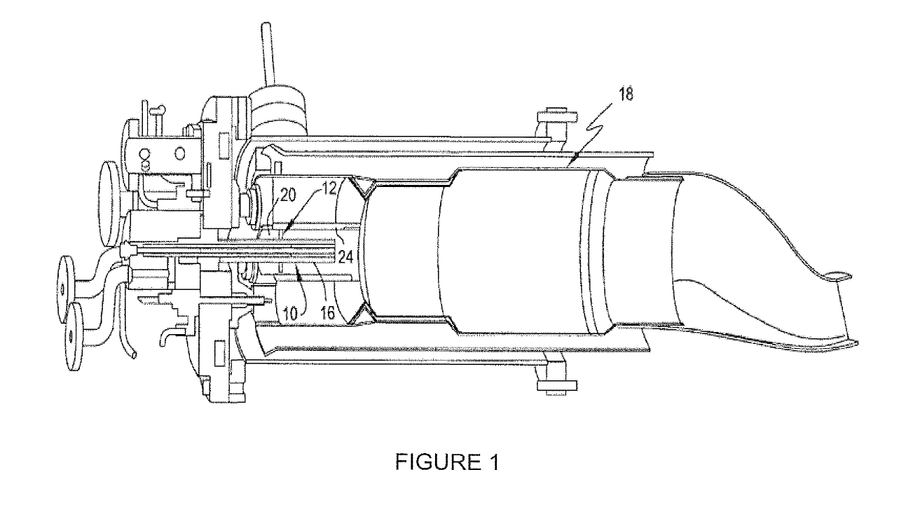

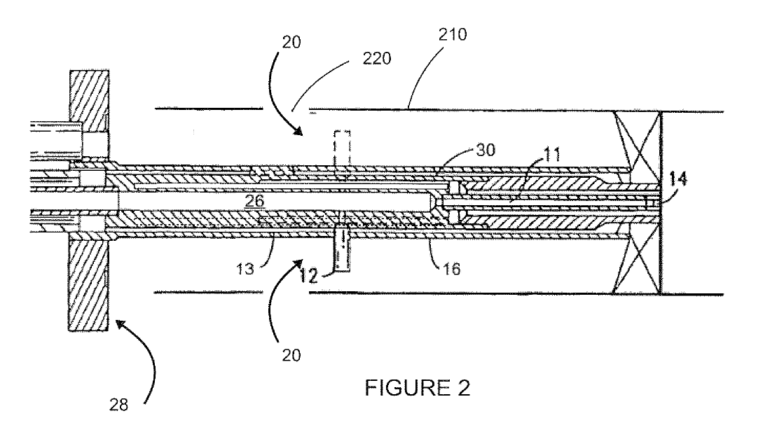

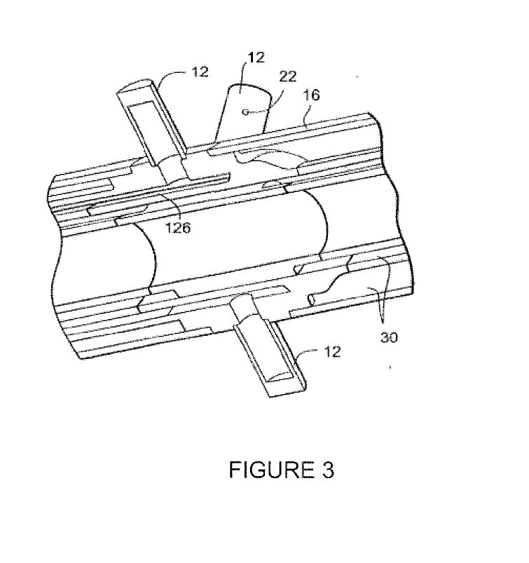

### DETAILED DESCRIPTION OF THE INVENTION

For ease of reading, terms “secondary fuel nozzle”, “fuel nozzle” and “nozzle” will be used interchangeably in this disclosure. As explained above, conventional nozzles include pegs in the flow area of the secondary air which can cause a substantial pressure drop in the air flow leading to many disadvantageous affects. In one or more embodiments of the inventive nozzle, fuel is injected upstream of the secondary air entry location. This removes the need for the pegs to deliver fuel for premixing.

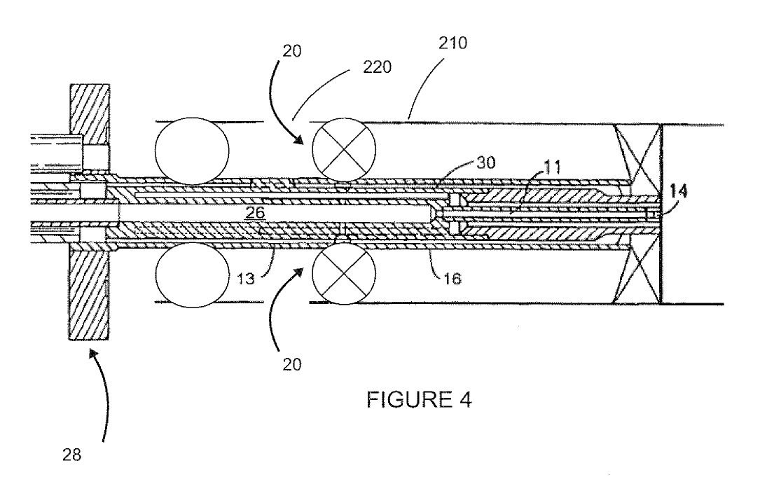

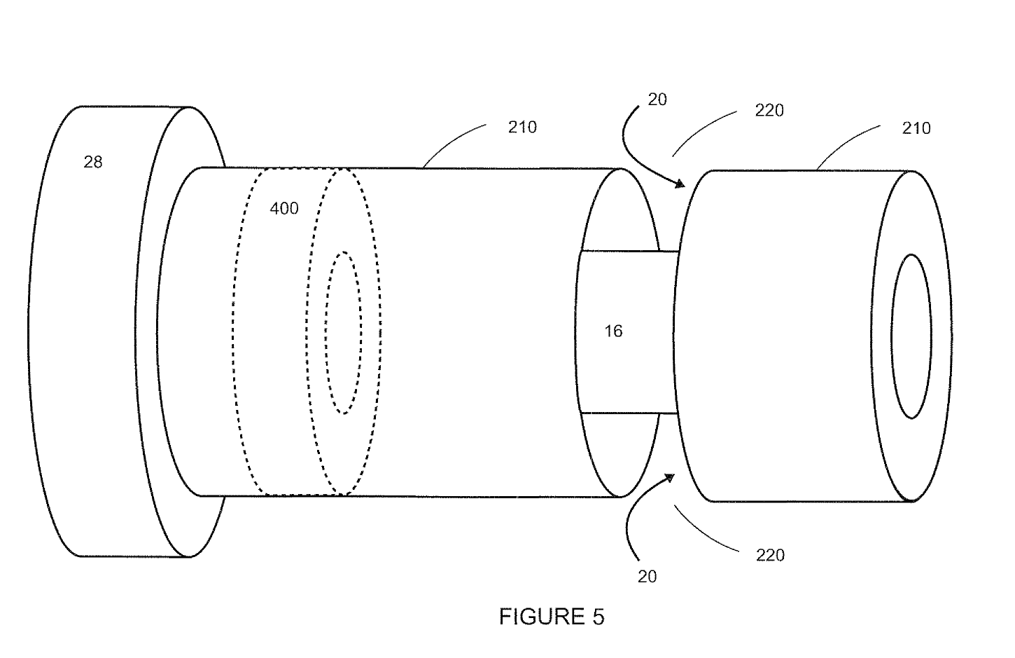

FIGS. 4 and 5 illustrate an example of providing fuel injection upstream of the secondary air entry location. In FIG. 4, crossed-out circles represent the location of pegs of the conventional fuel nozzle and non-crossed out circles represent preferred fuel injection location according to one or more embodiments of the present invention. As seen, the conventional fuel injection location is downstream of the secondary air entry location. In contrast, preferred fuel injection location is upstream of the secondary air entry location which corresponds to the location of the air passage 220 for the secondary air 20.

In FIG. 5 which provides a perspective view, the dashed area 400 corresponds to the non-crossed out circle of FIG. 4 and denotes the preferred location for fuel injection. Air passage 220 is defined by the nozzle housing 210 that surrounds the nozzle body 16. Secondary air 20 enters the nozzle housing 210 through the air passage 220 and flows rightward towards one end of the nozzle body 16 where the nozzle tip 14 is disposed. While only one air passage 220 is shown for simplicity, there can be multiple air passages 220 defined by the nozzle housing 210.

Injecting fuel upstream of the secondary air entry location removes the need for the fuel delivery pegs of the conventional secondary fuel nozzle. That is, the inventive secondary fuel nozzle can be free of fuel delivery pegs in the air flow area downstream of the air passages, which minimizes air flow blockage. The removal of pegs in the flow area correspondingly reduces the pressure drop which in turn enhances combustion efficiency and leads to lower emissions.

Other advantages also follow the inventive fuel nozzle. For example, injecting fuel upstream provides more length for fuel mixing. The reduced pressure drop can allow for a higher fraction of the combustor air flow to be used in the secondary fuel nozzle. There are also potential turndown, dynamics, and CO emissions benefits for increasing secondary air and fuel splits. Increasing the secondary air-fuel splits will help to have more stable secondary flame and will thus improve turndown and dynamics performance. Reducing pressure drop through the secondary fuel nozzle in turn reduces over all pressure drop that increases overall system efficiency. Upstream fuel injection improves the flexibility of using fuel nozzle designs for a wider range of fuel volumetric flows. Since fuel can be injected in a co-flow manner, it reduces blockage behind fuel injection that causes recirculation zones and flame holding in peg-style fuel injection. This arrangement also provides more fuel area with minimum blockage effect enhancing fuel flexibility of the system as low energy content fuels that require more area can be utilized in such nozzle.

While it is preferred that the fuel nozzle be free of pegs downstream of secondary air entry location, the invention does contemplate that at least some fuel injection can occur downstream. For example, a combination of upstream and downstream fuel injection is possible if the air flow blockage due to downstream fuel injection mechanism is minimal, i.e., it is at or below some predetermined tolerance level. It may be that in some instances, providing some fuel injection downstream may be beneficial in the overall premixing of fuel and air process. The downstream fuel injection, if provided, can be via pegs or other mechanisms.

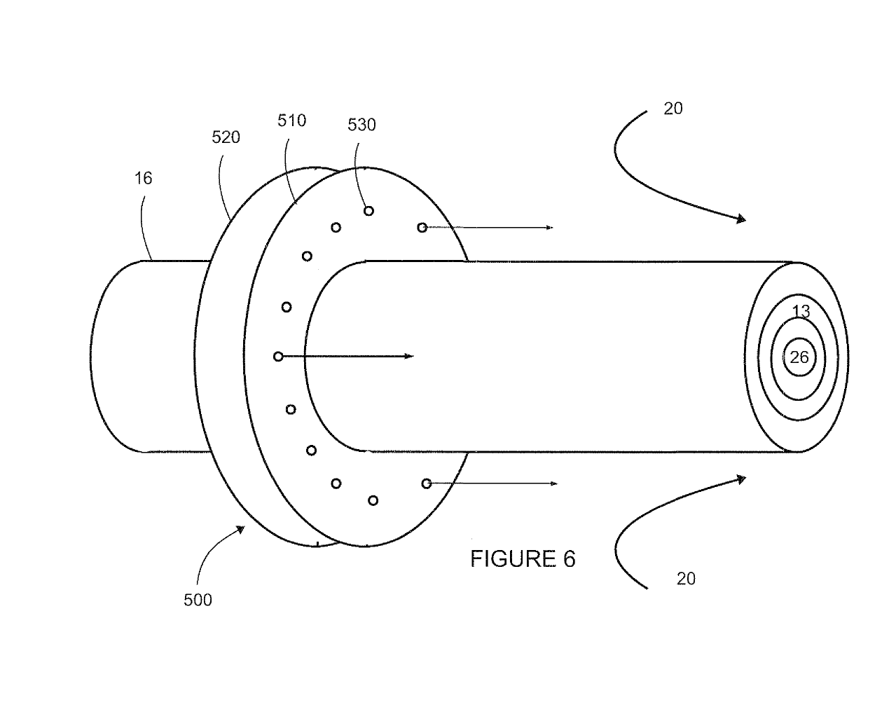

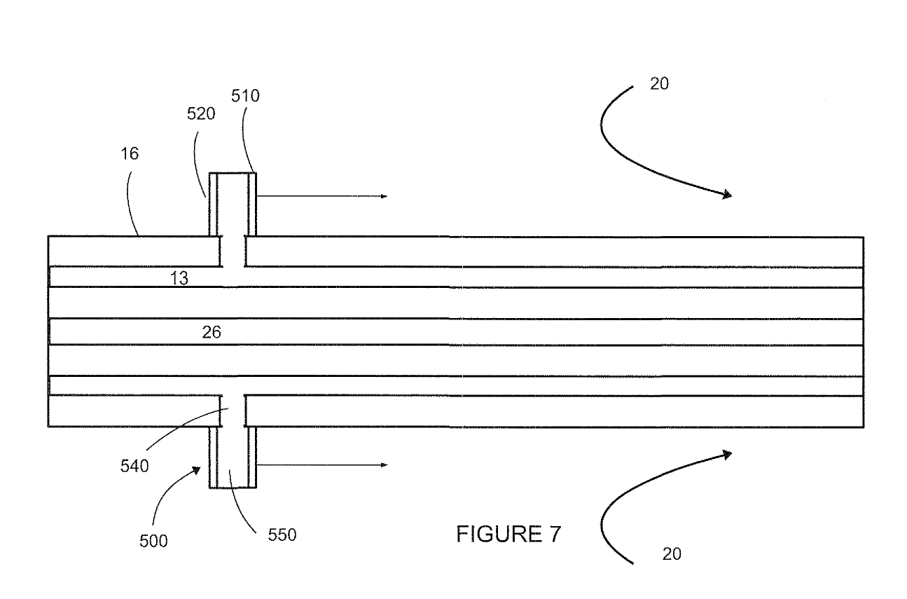

FIGS. 6 and 7 illustrate a first embodiment of a secondary fuel nozzle of the present invention. FIG. 6 is a perspective view and FIG. 7 is a cutout side view. The secondary fuel nozzle includes the nozzle body 16 arranged to deliver fuel for combustion in a gas turbine.

For simplicity of illustration, the nozzle housing 210 which surrounds the nozzle body 16 is omitted in these figures. The locations of the air passages 220 are illustrated by the secondary air 20 entering the nozzle housing 210 at predetermined lengthwise positions of the nozzle body 16. Secondary air 20 flows rightward towards one end of the nozzle body 16.

The first embodiment includes a premix fuel unit 500 positioned upstream of the air passages 220. The premix fuel unit 500 injects the fuel delivered by the nozzle body 16 into the secondary air 20 so as to premix the fuel and secondary air prior to combustion in the combustion chamber.

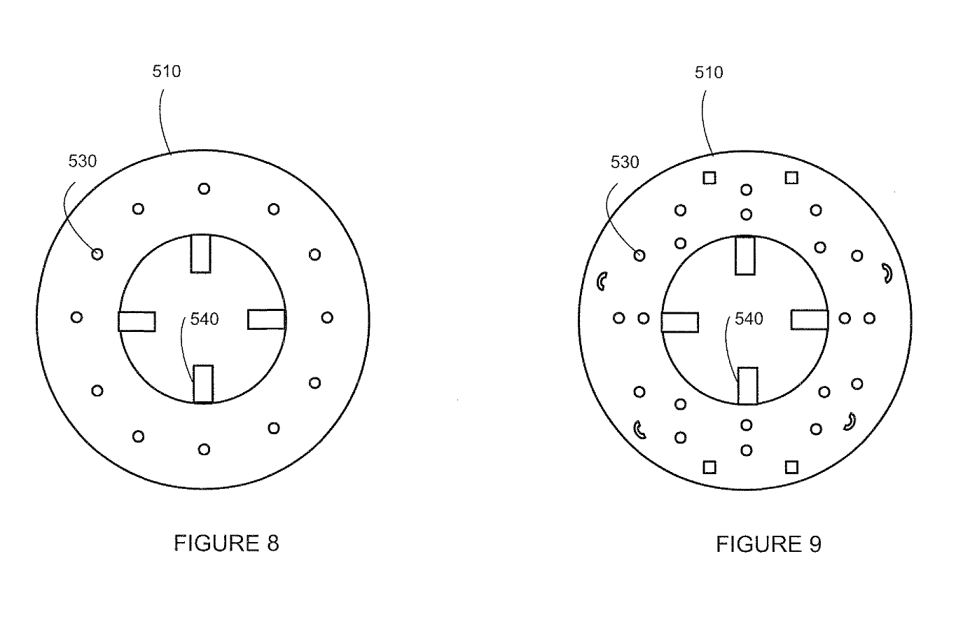

The fuel injected by the premix fuel unit 500 is fed from the nozzle body 16, and specifically, from one or more fuel feed conduits 13 provided within the nozzle body 16. As seen in FIG. 7, one or more premix connection conduits 540 connect the fuel feed conduit 13 to the premix fuel unit 500. FIG. 8, which provides a front view of the premix fuel unit 500, illustrates four premix connection conduits 540. However, the premix connection conduits 540 can be any in number and can be distributed around a circumference of the nozzle body 16 in any desired manner.

The fuel feed conduit 13 can run lengthwise from a base 28 to near the nozzle tip 14—nearly the whole length of the nozzle body 16 as seen in FIG. 4. But this is not strictly necessary. The fuel feed conduit 13 need only be provided along a portion of the length of the nozzle body 16 to enable connection with the premix connection conduits 540.

While a single fuel feed conduit 13 is illustrated for simplicity in FIGS. 6 and 7, it is contemplated that there can be multiple fuel feed conduits 13 to feed the premix fuel unit 500. When there are multiple fuel feed conduits 13, each may be controlled, for example, to have varying fuel delivery rates to provide more control over optimum premixing of fuel and air. The lengths of the fuel feed conduits 13 need not all be equal—each can be provided along a particular length of the nozzle body 16.

A central passage 26 can also be provided within the nozzle body 16. The central passage 26 delivers fuel to feed the diffusion pilot tube 11 to inject fuel directly into the combustion chamber 18.

The premix fuel unit 500 of the first embodiment includes a first plate 510 positioned upstream of the air passages 220 and a second plate 520 positioned further upstream so as to form a fuel plenum 550 with a volumetric space defined between the plates 510, 520. A plurality of fuel injection holes 530 are provided on the first plate 510. The premix connection conduits 540 connect the fuel plenum 550 to the fuel delivery conduits 13 so that the fuel plenum 550 can be filled with the fuel which is injected into the secondary air 20 via the plurality of fuel injection holes 530.

The separation between the first and second plates 510, 520 should be enough to create the volumetric space needed for uniform fuel distribution inside the fuel plenum 550 from which the fuel contained within the space can be injected into the air stream 20. Not having sufficient volume inside the fuel plenum 550 can cause fuel non-uniform distribution inside the fuel plenum 550 leading to non-uniform fuel injection through the fuel injection holes 530 that will results in reduced air-fuel mixing necessary for lower emissions. In addition non-uniform distribution could also affect flame holding capability of the nozzle. In one embodiment, the volumetric space of the fuel plenum 550 is laterally defined by the first and second plates 510, 520 and radially and circumferentially by the nozzle body 16 and the nozzle housing 210.

The fuel injection holes 530, in a simple arrangement, can be arranged circumferentially as illustrated in FIG. 8. It should be noted that the arrangements of the fuel injection holes 530 need not be limited to any particular radial distance from a center of the first plate 510. Indeed, it is preferred that the fuel injection holes 530 be distributed so as to vary radially, circumferentially, or both as illustrated in FIG. 9. That is, between two injections holes 530, they can be arranged on the first plate 510 in locations different from each other radially, circumferentially, or both.

The distribution of the fuel injection holes 530 need not be regular. For example, to minimize wetting of the surface of the nozzle body 16, the fuel injection holes 530 can be distributed such that more are provided at radially further distances from the center. The holes 530 are not limited to any particular shape as well—they can be circles, squares, rectangles, arcs, and so on. In addition, the sizes of the holes 530 are not limited. One or more factors regarding the fuel injection holes 530—distribution, shape, size—can be varied to provide a desired fuel injection pattern and amount so as to optimize the premixing of fuel with air to achieve efficient combustion.

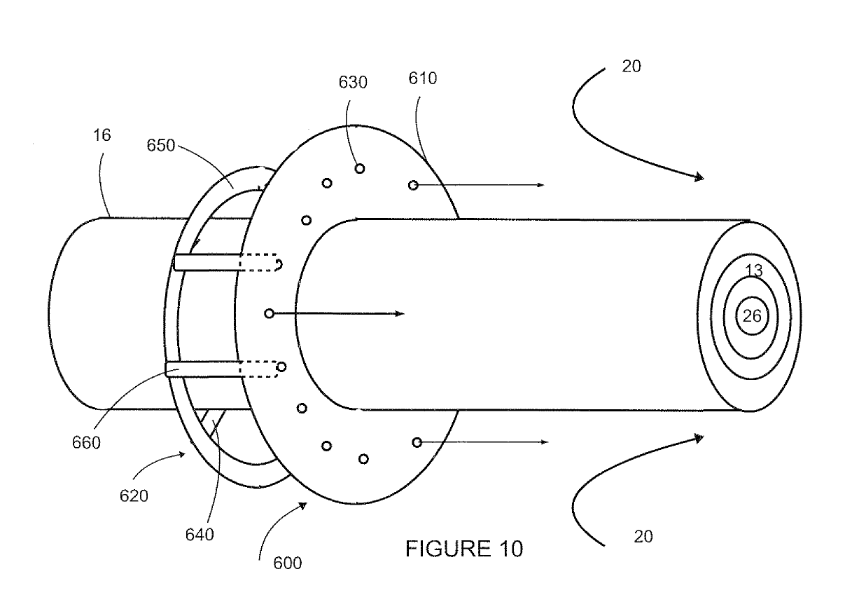

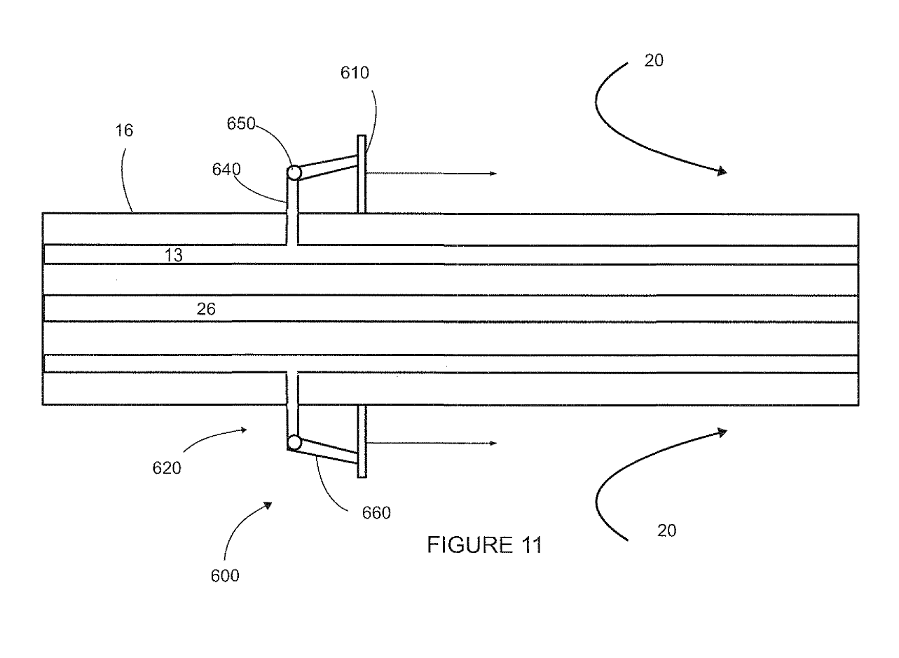

FIGS. 10 and 11 illustrate a second embodiment of the secondary fuel nozzle of the present invention. FIG. 10 is a perspective view and FIG. 11 is a cutout side view. Again for simplicity, the nozzle housing 210 is not illustrated. Similar to the first embodiment, the second embodiment includes the nozzle body 16 and the secondary air 20 entering the air passages 220 defined by the nozzle housing 210 flows rightward toward one end of the nozzle body 16.

One difference between the two embodiments is in the premix fuel unit. The premix fuel unit 600 of the second embodiment includes a plate 610 with a plurality of fuel injection holes 630 located upstream of the air passages 220 much like the first plate 510 of the first embodiment. However, instead of forming a fuel plenum with another plate, the second embodiment premix fuel unit 600 includes a fuel manifold 620 positioned further upstream of the air passages 220. The fuel manifold 620 delivers fuel from the nozzle body 16 to the fuel injection holes 630 so as to inject fuel into the secondary air 20.

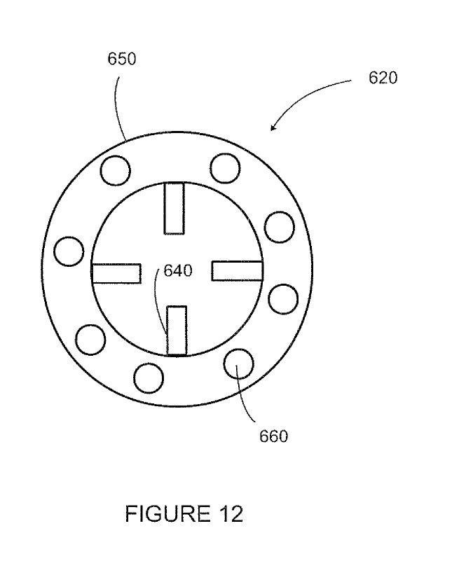

As seen in FIG. 12, the fuel manifold 620 includes a fuel distribution body 650 and one or more premix connection conduits 640 connecting the fuel distribution body 650 to the fuel delivery conduits 13. The premix connection conduits 640 of the second embodiment serve functions similar to the premix connection conduits 540 of the first embodiment.

The fuel manifold 620 also includes a plurality of distribution connections 660. As seen in FIGS. 10 and 11, the distribution connections 660 connect the fuel distribution body 650 to the fuel injection holes 630 so that the fuel from the nozzle body 16 is injected into the secondary air 20 via the fuel injection holes 630.

In FIG. 10, only two fuel injection holes 630 are shown as being connected with the distribution body 650 through the distribution connections 660. This is done so as to minimize clutter in the figure. In actuality, it is much more preferred that each fuel injection hole 630 be connected. This is because one of the functions that the plate 610 serves is to prevent air from entering the cavity on the left of the premix fuel unit 600 which can create a flame holding region. Having unconnected fuel injection holes 630 can allow some air to flow backwards into the cavity potentially creating such undesirable flame holding region.

It should be noted however that the invention does contemplate leaving one or more fuel injection holes 630 unconnected to the extent that the likelihood of the flame holding region from occurring is minimal, i.e., the likelihood is maintained at a predetermined threshold level or below. For example, a separate mechanism to seal some or all unconnected fuel injection holes 630 can be provided.

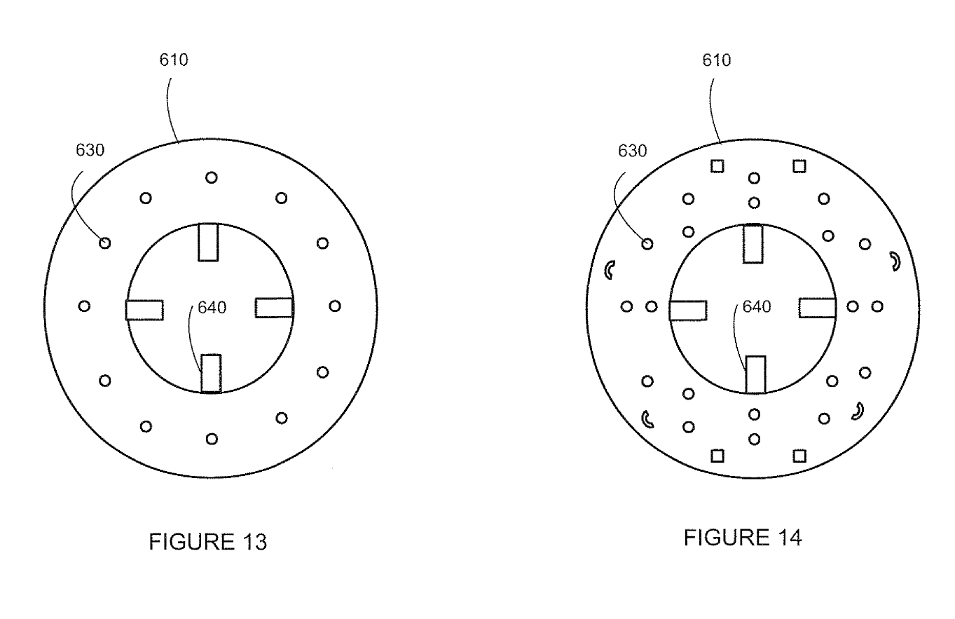

Similar to the first embodiment, the plurality of fuel injection holes 630 can arranged to be varied in a variety of ways. As seen in FIGS. 13 and 14, the fuel injection holes 630 can be located to be vary radially and/or circumferentially. Also the sizes and/or shapes can vary.

One advantage of the second embodiment's fuel manifold 620 over the first embodiment's volumetric space 550 is that possibility of fuel leak is reduced. For example, the first and second plates 510, 520 may be welded only on the inner circumference. On the outer circumference, the clearance gap between the plates and nozzle body 210 may be closed with a seal. In the event of a seal failure, fuel may leak into the air stream. However, in case of second embodiment, even when the seal fails, leakage is less likely since fuel is supplied through distribution connections 660. Thus possibility of fuel leak is reduced. In addition, also in the event of the seal failure, air may rush into to the volumetric space between the plates 510, 520 in the first embodiment. However, in the case of the second embodiment, air will not come in contact with fuel since fuel is passed through the closed distribution connections 660.

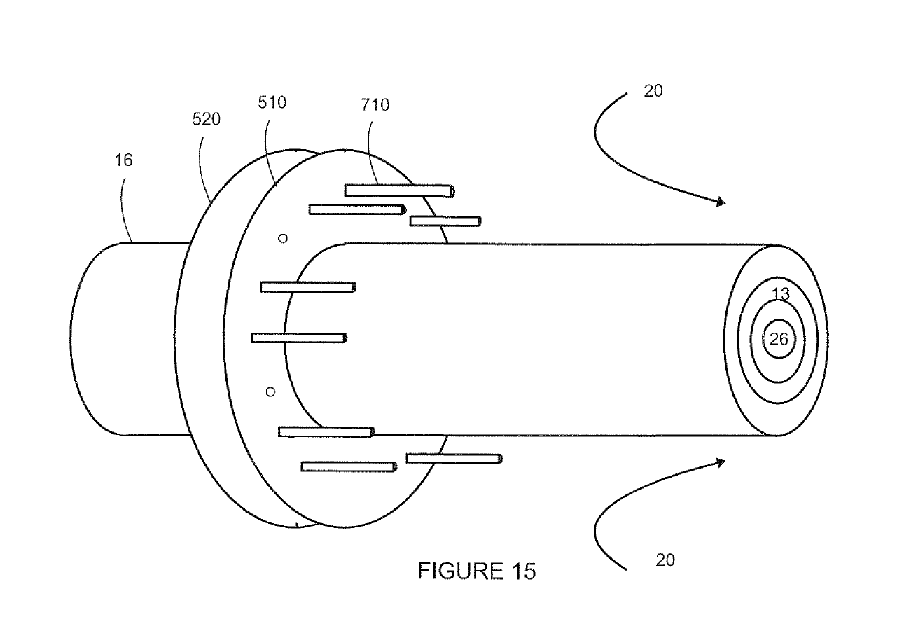

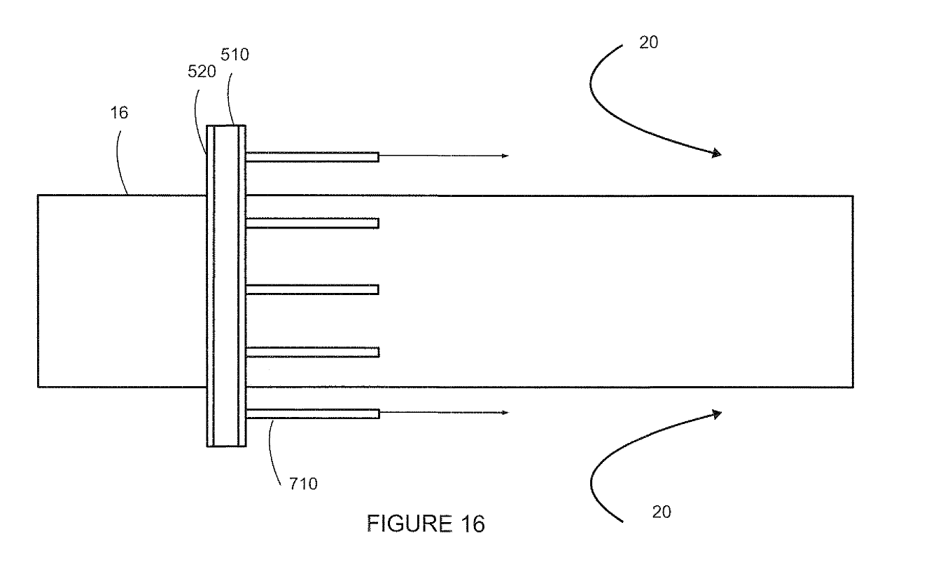

FIGS. 15 and 16 illustrate a third fuel nozzle embodiment. FIG. 15 is a perspective view and FIG. 16 is a cutout side view. The third embodiment may be viewed as an extension of the first embodiment in that it comprises all elements of the first embodiment such as the nozzle body 16 and the premix fuel unit 500. But in addition, the one or more fuel extension tubes 710 are provided. Each fuel extension tube 710 extends from one of the fuel injection holes 530 toward the air passages 220. The fuel extension tubes 710 allow design flexibility in determining precise location where the fuel is first premixed with air.

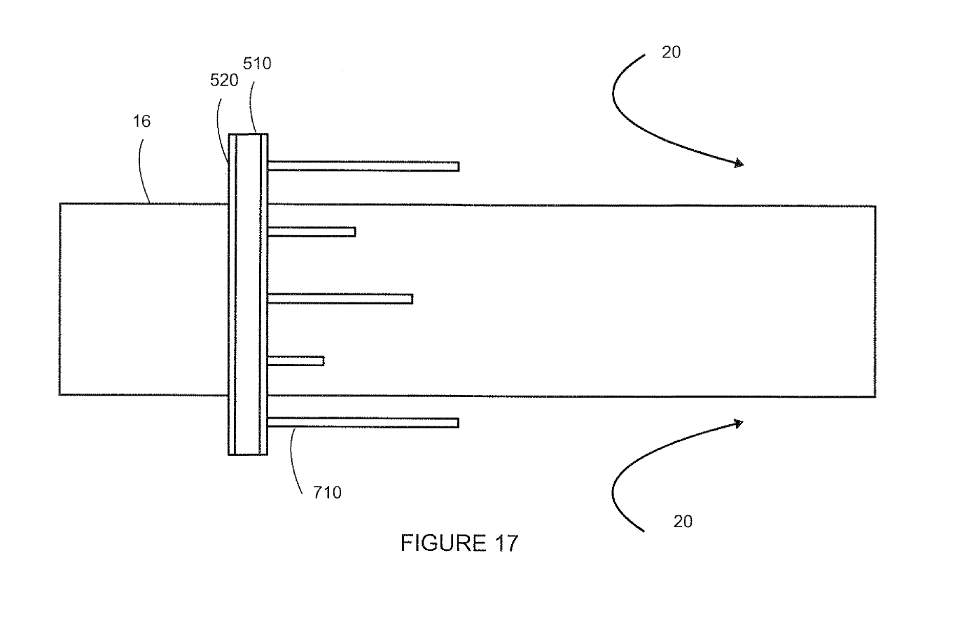

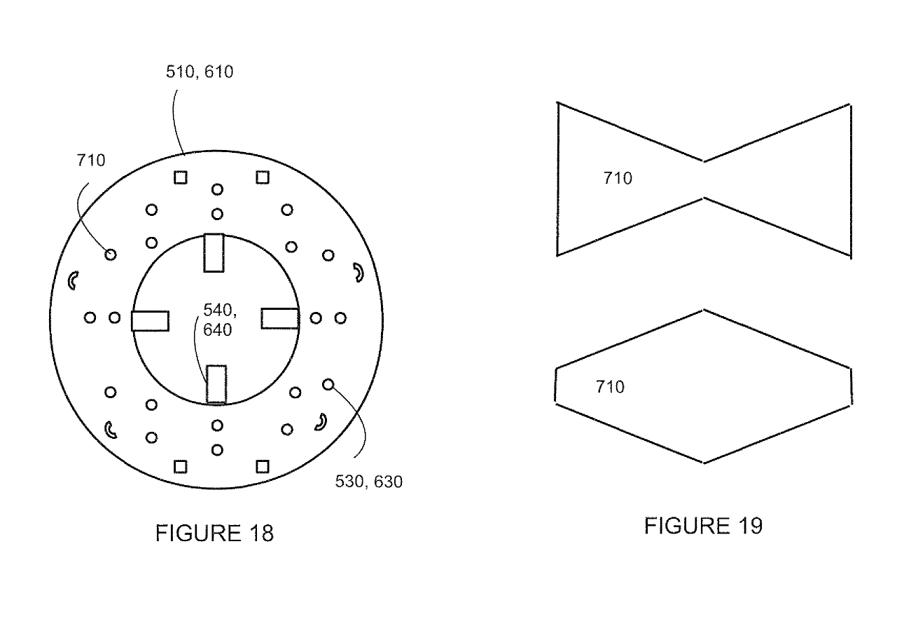

Indeed, in some instances, it may actually be more preferable to vary the lengths of the fuel extension tubes 710 as illustrated in FIG. 17. The fuel extension tube lengths can vary between zero (i.e, no fuel extension tube) and a predetermined length. The fuel extension tubes 710 need not all be of same shape. In FIG. 18, it is seen that some tubes 710 have cross-sectional circular shapes, others have square shapes, and so on. Also, some of the fuel injection holes 530, 630 have no fuel extension tubes 710 connected at all. Generally, between any two fuel extension tubes 710, the tubes can differ in their lengths, shapes, and/or sizes.

Yet further, the cross-sectional shape and/or size along a length of any one fuel extension tube 710 need not remain constant. The view of the fuel extension tubes 710 in FIG. 19 is exaggerated to illustrate that the shape of any one fuel extension tube 710 can vary along its length. Again, the possibility to vary the fuel extension tubes 710 provides extra degree of flexibility to optimize fuel and air premix for efficient combustion.

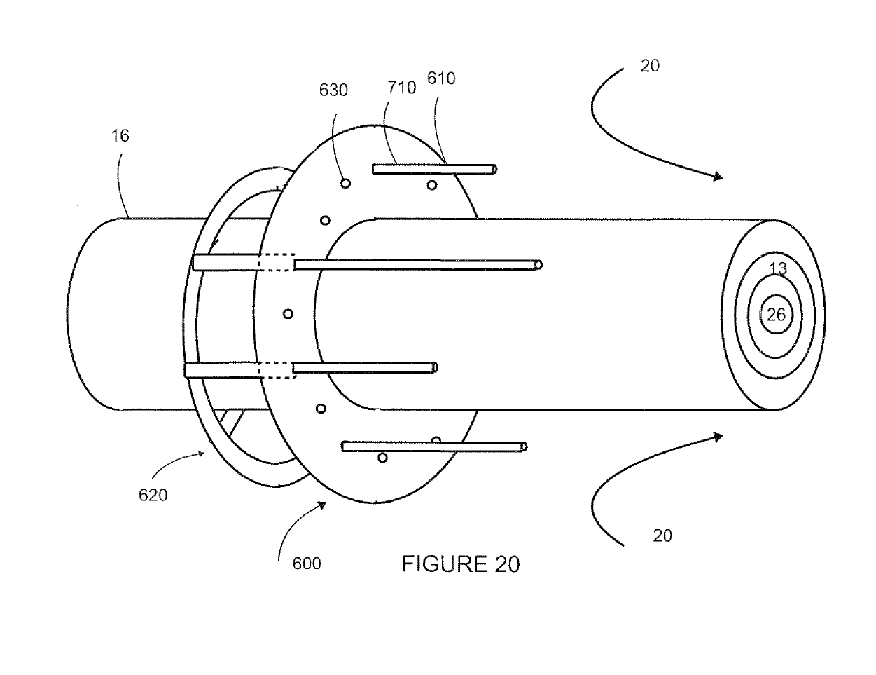

FIG. 20 shows another variation in that the fuel extension tubes 710 extend from the fuel injection holes 630 of the second embodiment. This variation may be viewed as an extension of the second embodiment fuel nozzle. Again, not all distribution connections 660 are illustrated so as to minimize clutter in the figure. However, it is understood that substantially all fuel injection holes 630 are connected to the fuel distribution body 650 through the distribution connections 660 to prevent/minimize the occurrence of the flame holding region.

This variation also allows the flexibility of determining the characteristics of the fuel extension tubes 710 connected to the fuel injection holes 630 including lengths, shapes, sizes, and shapes along lengths of individual fuel extension tubes 710. There also is the option of not providing the fuel extension tube 710 for some of the fuel injection holes 630.

While not illustrated, it is allowable to have one or more fuel extension tubes 710 that extend such that fuel is injected downstream of the air passages 220. Preferably, the air flow blockage caused by such extension tubes 710 is kept at or below a predetermined level. Also while not illustrated, the extension direction of the fuel extension tubes 710 can vary as well. While it may be preferred that the fuel extension tubes 710 extend in a direction that is substantially parallel to the nozzle body 16, in some instances, it may be that having some fuel extension tubes 710 extending in a non-parallel direction may promote better total fuel and air premix.

The inventive secondary fuel nozzle embodiments may be used to premixed fuel and air into a combustion chamber 18 of a gas turbine for combustion.

It will thus be appreciated that the inventive secondary fuel nozzle provides many benefits. A non-exhaustive list of such advantages include: removal of pegs in the flow area correspondingly reduces the pressure drop which can enhance combustion efficiency and lead to lower emissions; injecting fuel upstream provides more length for fuel mixing; the reduced pressure drop allows for a higher fraction of the combustor air flow to be used in the secondary fuel nozzle; turndown, dynamics, and CO emissions benefits for increasing secondary air and fuel splits; and upstream fuel injection improves the flexibility of using the inventive fuel nozzle design for a wider range of fuel volumetric flows including using fuel with lower energy content.

While the invention has been described in connection with what is presently considered to be the most practical and preferred embodiment, it is to be understood that the invention is not to be limited to the disclosed embodiments. The invention is intended to cover various modifications and equivalent arrangements included within the spirit and scope of the appended claims.

What is claimed is:

1. A secondary fuel nozzle, comprising:
a nozzle body arranged to deliver fuel for combustion in a gas turbine;
a nozzle housing surrounding said nozzle body, said nozzle housing defining one or more air passages at predetermined lengthwise positions of said nozzle body such that secondary air entering said nozzle housing flows from said one or more air passages toward one end of said nozzle body; and
a premix fuel unit positioned upstream of said one or more air passages and arranged to inject fuel delivered by said nozzle body into said secondary air to premix fuel and air prior to combustion.

2. The secondary fuel nozzle of claim 1, wherein one or more fuel delivery conduits are provided within said nozzle body so as to feed said premix fuel unit with said fuel to be injected, each fuel delivery conduit being provided along at least a portion of a length of said nozzle body.

3. The secondary fuel nozzle of claim 1, wherein said premix fuel unit comprises:
a first plate positioned upstream of said one or more air passages;
a second plate positioned further upstream of said one or more air passages so as to form a fuel plenum with a volumetric space defined between said first and second plates, said fuel plenum arranged to be filled with said fuel delivered from said nozzle body; and
a plurality of fuel injection holes provided on said first plate and arranged such that said fuel in said fuel plenum is injected into said secondary air via said plurality of fuel injection holes.

4. The secondary fuel nozzle of claim 3, wherein
one or more fuel delivery conduits are provided within said nozzle body, each along a length portion said nozzle body, and
said premix fuel unit further comprises one or more premix connection conduits connecting said fuel plenum to said one or more fuel delivery conduits so as to feed said fuel plenum with said fuel to be injected.

5. The secondary fuel nozzle of claim 3, wherein at least two of said plurality of fuel injection holes are arranged on said first plate in locations different from each other radially, circumferentially, or both.

6. The secondary fuel nozzle of claim 3, wherein at least two of said plurality of fuel injection holes are different in shape, size, or both.

7. The secondary fuel nozzle of claim 3, further comprising one or more fuel extension tubes, each extending from one of said plurality of fuel injection holes toward said one or more air passages.

8. The secondary fuel nozzle of claim 7, wherein at least two of said fuel extension tubes are different in one or more of length, shape, and size.

9. The secondary fuel nozzle of claim 7, wherein shape, size, or both of at least one fuel extension tube vary along its length.

10. The secondary fuel nozzle of claim 7, wherein at least one fuel injection hole does not have a fuel extension tube extending therefrom.

11. The secondary fuel nozzle of claim 1, wherein said premix fuel unit comprises:
a plate positioned upstream of said one or more air passages;
a plurality of fuel injection holes provided on said plate; and
a fuel manifold positioned further upstream of said one or more air passages, and arranged to deliver fuel from said nozzle body to said plurality of fuel injection holes so as to inject said fuel into said secondary air via said plurality of fuel injection holes.

12. The secondary fuel nozzle of claim 11, wherein
one or more fuel delivery conduits are provided within said nozzle body, each along a length portion said nozzle body, and
said fuel manifold comprises:
a fuel distribution body;
one or more premix connection conduits connecting said fuel distribution body to said one or more fuel delivery conduits; and
a plurality of distribution connections, connecting said fuel distribution body to said plurality of fuel injection holes.

13. The secondary fuel nozzle of claim 11, wherein at least two of said plurality of fuel injection holes are arranged on said plate in locations different from each other radially, circumferentially, or both.

14. The secondary fuel nozzle of claim 11, wherein at least two of said plurality of fuel injection holes are different in shape, size, or both.

15. The secondary fuel nozzle of claim 11, further comprising one or more fuel extension tubes, each extending from one of said plurality of fuel injection holes toward said one or more air passages.

16. The secondary fuel nozzle of claim 15, wherein at least two of said fuel extension tubes are different in any one or more of length, shape, and size.

17. The secondary fuel nozzle of claim 15, wherein a shape, size, or both of at least one fuel extension tube vary along its length.

18. The secondary fuel nozzle of claim 15, wherein at least one fuel injection hole does not have a fuel extension tube extending therefrom.

19. The secondary fuel nozzle of claim 1, wherein said secondary fuel nozzle is free of fuel delivery pegs in a flow area downstream of said one or more air passages.

20. A gas turbine, comprising:
a combustion chamber; and
a secondary fuel nozzle of claim 1 arranged to provide premixed fuel and air into said combustion chamber for combustion.
